(19) United States
(12) Patent Application Publication
(10) Pub. No.: US 2002/0077069 A1
(43) Pub. Date: Jun. 20, 2002

(54) Mobile telephone provided with a camera and programming method

(75) Inventor: Frederic Heurtaux, Le Puy Ste Reparade (FR)

Correspondence Address: BOYLE FREDRICKSON NEWHOLM STEIN & GRATZ, S.C., 250 E. WISCONSIN AVENUE, SUITE 1030, MILWAUKEE, WI, 53202, US

(73) Assignee: SAGEM SA, Paris (FR)

(21) Appl. No.: 09/859,876

(22) Filed: May 17, 2001

(30) Foreign Application Priority Data
May 17, 2000 (FR) 00 06485

(51) Int. Cl. H04B 1/38

(52) U.S. Cl. 455/90; 455/556; 348/14.01

(57) ABSTRACT

A mobile telephone provided with a camera is made. This telephone is capable of modifying its parameters through a reading of bar codes. The telephone has software for the reading and interpretation of bar codes. This method is designed for the low-cost, mass programming of mobile telephones.

### BACKGROUND OF THE INVENTION

1. Field of the Invention

An object of the invention is a mobile telephone provided with a camera as well as a method for programming it. The field of application is mobile telephony for both speech communication and data communication. The aim of the invention is to increase the functional capacities of mobile telephones.

2. Description of the Prior Art

To modify a parameter of a mobile telephone, it is usually necessary to consult a specialist. This specialist has software and hardware tools for the efficient modification of the mobile telephone. This modification in most cases is a modification of an operating system of the mobile telephone. This modification is done in practice by releasing functions that were initially contained in an installed operating system, but have been temporarily neutralized (especially for reasons of taking out subscriptions to additional options of use of the mobile telephone). The operation cannot be performed by a private individual. The problems of such a situation are, in particular, its considerable cost, which ultimately has to be paid by the user, the loss of time and the complexity of the approach. An updating of this kind generally requires the presence of a back panel connector in the mobile telephone.

In the invention, to resolve these problems, bar codes are used to modify these blocking parameters and more generally the use parameters of the mobile telephone. The use of bar codes to identify products is known. Thus, bar codes are for example used to determine a price or a book reference in a library. There is also a known simplified means, using a bar code of a film, to program a televised recording. In the invention, a bar code corresponds especially to a releasing code used to release a function of the mobile telephone. More generally, a bar code corresponds to a parameter of use of the mobile telephone. In the invention, to make use of a bar code of this kind to modify the mode of use of the mobile telephone, a camera of the mobile telephone along with supplementary circuits are used. These supplementary circuits are used for reading, decoding and interpreting a bar code. The mobile telephone can then be parametrized in the course of time in a simplified way.

### SUMMARY OF THE INVENTION

The invention therefore relates to mobile telephone comprising a camera, a microprocessor and a program memory characterized in that, to read bar codes with the camera, the program memory memorizes a subprogram used to convert a signal in a video format, recorded by the camera and representing an image of a bar code to be read, into a digital format signal representing this bar code, and in that the telephone comprises circuits to interpret these bar codes.

The invention also relates to a method for the programming of a mobile telephone, characterized in that it comprises the following steps

a bar code is read with a camera of this mobile telephone,

and the telephone is programmed with the contents of a bar code read.

### BRIEF DESCRIPTION OF THE DRAWINGS

The present invention will be understood more clearly from the following description and the appended figures. These figures are given purely by way of an indication and in no way restrict the scope of the invention. Of these figures:

FIG. 1 shows a mobile telephone according to the invention, with its camera is aimed at the document to be studied;

FIGS. 2a to 3c are diagrammatic views of a mobile telephone according to the invention;

FIG. 3 is a diagrammatic view of the contents of a mobile telephone according to the invention;

FIG. 4 shows an image of a bar code.

### MORE DETAILED DESCRIPTION

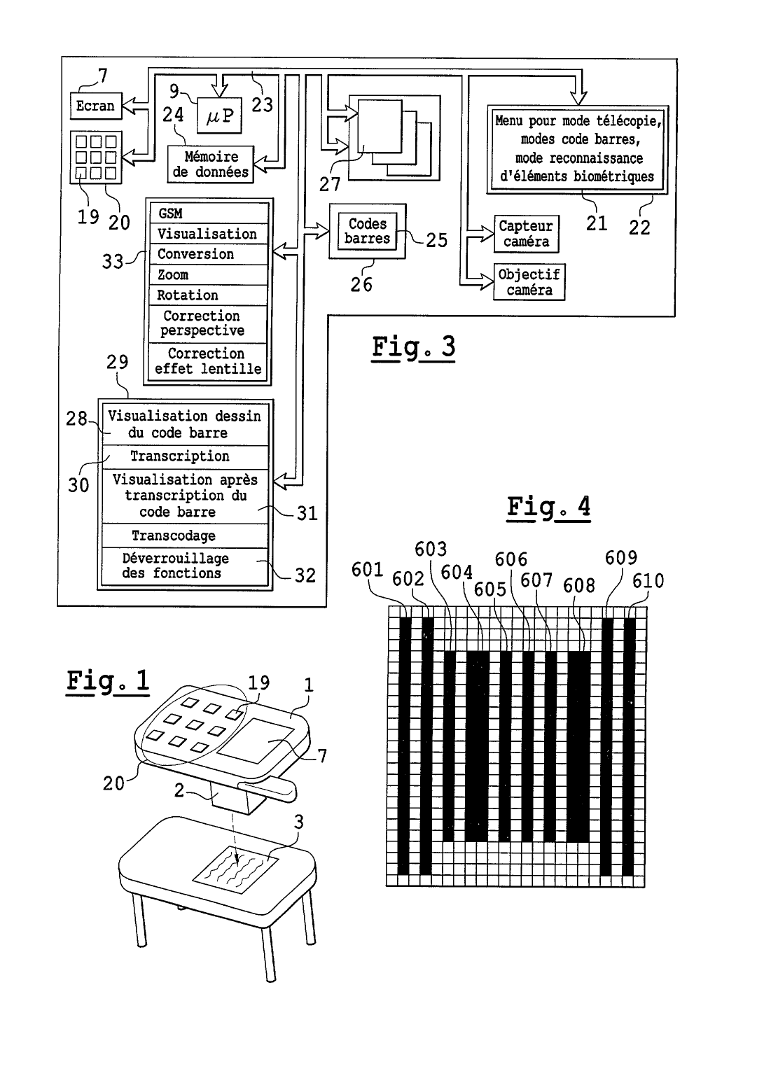

FIG. 1 shows a mobile telephone 1 according to the invention. It has a camera 2. The camera 2 is aimed at the document 3. The camera 2 may be for example a 640×480 color camera with 256 colors. To pick up any image of the document to be examined, the camera may have a dioptre set with two focal lenses or one set of straight lenses.

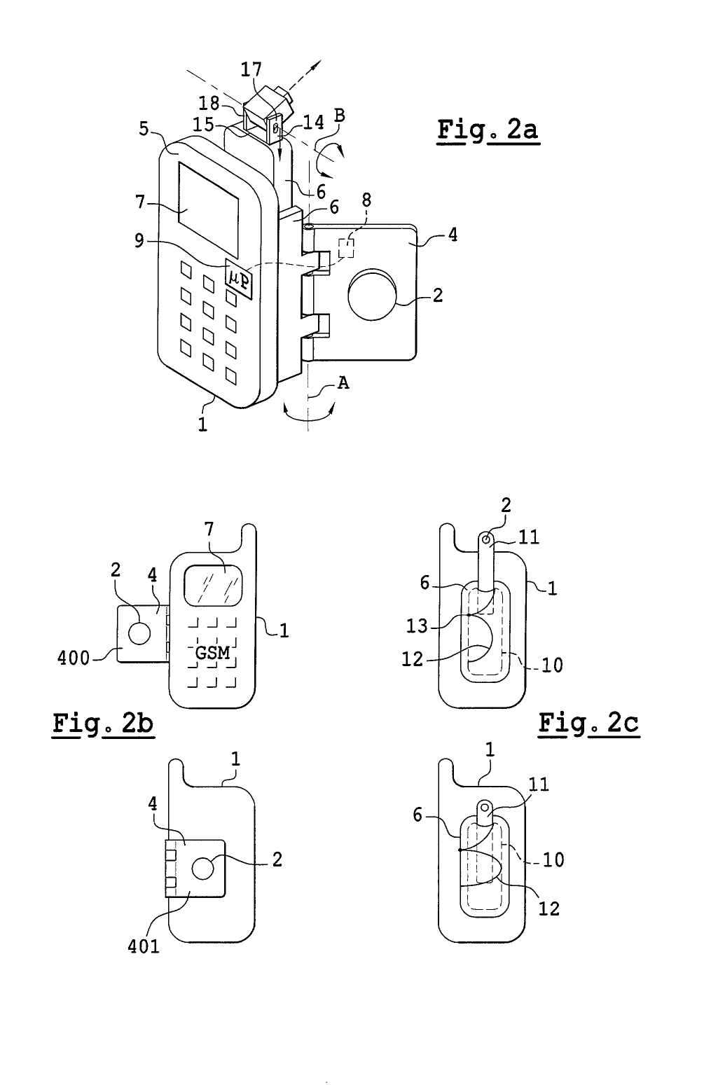

FIGS. 2a, 2b and 2c show different embodiments of the camera 2. Three approaches especially can be envisaged. In a first approach shown in FIG. 2a, it is proposed to install the camera 2 on a hinged shutter 4. The shutter 4 is anchored to a box 5 of the telephone 1 or to a detachable pack 6 of a battery of the telephone 1. FIG. 2a shows 3D view of an approach of this kind.

FIG. 2b shows the approach using the hinged shutter 4 in two positions 400 and 401 for the camera 2. In the case of the position 400, the objective of the camera 2 is oriented on the same side as a screen 7 of the mobile telephone 1. The position 401 corresponds to the case where the pivoting shutter is folded down on the other side of the mobile telephone. Thus, the objective of the camera 2 is directed, for the position 401, from the side of the telephone pack where there is no screen 7. To know the position in which the pivoting shutter 4 is placed, a photoelectric cell 8 may be placed on the pivoting shutter 4 side where there is no objective. This photoelectric cell 8 is connected to a microprocessor 9 of the telephone 1 managing the general operation of this telephone 1. Depending on the illumination received by this photoelectric cell 8, the microprocessor 9 will have a piece of information revealing the orientation of the shutter. Indeed, if the cell 8 receives light, the shutter 4 is in the position 400. If not, the shutter 4 is in the position 401.

In another embodiment, the photoelectric cell 8 may be replaced by a Reed bulb or electrical circuits to cope with problems of luminosity.

The shutter 4 can pivot about an axis A parallel to one side of the pack 6 of the battery. The rotation of the shutter 4 about the axis A is permitted by means of hinges fixed along one side of the pack 6. The geometrical shape of the shutter 4 may be rectangular but not only rectangular. A circular or again an oval shape could also be envisaged.

FIG. 2c shows a second approach with a periscope. A housing 10 for a periscope 11 is made, for example, in the pack of the battery 6. The camera 2 is installed at the head of the periscope 11. The objective of the camera is on a face of the rod of the periscope 11. Thus, the periscope 11 can be fitted into the pack 6.

When the periscope 11 moves, it may take a helical path 12. And the current position of the periscope 11 determines the orientation of the objective of the camera, namely respectively the orientation corresponding to the position 401 (with the periscope in the low position) or the position 400 (periscope in the top position). The current position of the periscope 11 determines for example by the state of a switch 13. The switch 13 may be replaced by a control button. A closed or open state of the switch 13 is interpreted by the microprocessor 9. The current position of the periscope 11 corresponds for example to a videoconference position. An open state of the switch 13 corresponds to position for making readings of bar codes.

However, these approaches do not propose any protection of the objective of the camera 2. The objective is always uncovered. To resolve this problem, it is possible to consider a periscope 14 of the kind shown in FIG. 3a, in which a housing is designed to accept the camera 2. The camera 2 is then retractable. The camera 2 preferably pivots about an axis B in such a way that the objective of the camera can be protected. Either this camera is oriented towards the base of the mobile telephone and the camera is made to enter a housing 15 or the objective is protruding and oriented like the screen 7 or in the opposite direction.

The rotational axis B of the camera 2 has mobile bearings 17 and 18 at each of its ends. The mobile bearings 17 and 18 are borne by parallelepiped uprights having a motion parallel to the motion of the periscope 14 in the housing 15 designed for the camera. Circuits installed on the mobile camera 2 are connected to the microprocessor 9 by means of connectors located for example on the mobile bearings 17 and 18. Depending on whether the objective is pointed on the same side of the screen or not, one part or other of these circuits is facing the connectors. The microprocessor 9 may interpret this type of connection to deduce the orientation of the camera therefrom.

The orientation of the camera 2 preferably determines the nature of the operations to be performed. The nature of the orientation of the camera 2 is determined by the recognition of the current position of the camera 2.

FIG. 3 shows a set of circuits contained in the mobile telephone 1 according to the invention. If a user wishes to use the camera 2, according to a manual embodiment, he places the camera 2 in the appropriate position corresponding to the operation that he wishes to perform, for example to read a bar code on the document 3. The camera 2 is then preferably in the position 401.

The user then specifies the way in which he chooses to use the camera 2, for example by pressing a button 19 of a control keypad 20 of the telephone 1. The microprocessor 9 had identified and interpreted the current position of the camera 2. A program 21 of a memory program 22 then causes a display on the screen 7 of a menu proposing the use of a mode for the reading of bar codes, or a fax mode, the recognition of biometric elements or the like. All the choices made by the user are memorized by means of the bus 23 in this data memory 24.

If the user decides to read bar codes, he chooses the corresponding mode in the menu of the program 21. A program 25 of a program memory 26 is then launched accordingly and used to manage the read mode of the bar codes. In the preferred application, a bar code represents the use of an unlocking code for unlocking a function of the mobile telephone.

According to the program 25, an image of the bar code is first of all stored in a file 27. The entered or memorized bar code can also be displayed by means of a program 28 contained in a program memory 29. Then, a program 30 contained in the program memory 29 transcribes the drawing of the bar code into a number.

By displaying the bar code, it is possible to carry out a focusing operation. Should the focal lens be fixed, the bar code, in one example, comprises a pattern used for the focusing. This focusing is helped by the screen 7 which may indicate a quality of the picked-up image, for example by means of an indicator (higher or lower for each corner of the image) so as to obtain a better orientation.

FIG. 4 shows a diagrammatic view of a bar code. The drawing of the bar code comprises several vertical bars 601 to 610 having two different lengths. A first length corresponds to the start or to the end of the bar code (601 and 602, 609 and 610). A second length, smaller than the first length, defines the bar code itself (603 to 609). The bars with small lengths do not all have the same width. Thus, the bars 604 and 609 are wider than the bars 603 and 605 to 607. The distribution and the nature of the bars 603-609 represent the bar code itself, namely a particular number. This representation is dictated by proprietary standards and protocols.

This particular number, which is a signal transcribed in decoded form and representing the bar code, may also be displayed on the screen 7 by means of a program 21 contained in the program memory 29. This particular number is a releasing code and is stored in the data memory 24. A releasing program 32 is then used to unlock a function by means of a particular number and modify the working of the mobile telephone accordingly. In order to be taken into account, such an unlocking may require that the mobile telephone 1 be stopped and then put back into operation. The functions of initializing the mobile telephone are then used to configure it, depending on the new parameters recorded, in a mode of operation including the released functions. In this case, the functions of the mobile telephone, contained for example in a program memory T3, will each be associated with an index which, depending on its value, permits the execution on non-execution of the function. It is this index that is modified during the unlocking.

Once the camera has read the bar code, the telephone is programmed with the bar code read.

A first way of programming the mobile telephone with bar codes would be to use a scratch card. A scratch card is a card that is purchased from a distributor and has portions concealed by a film-covered zone. In this case, it is preferably planned that an IMEI number, which is a serial number, of the mobile telephone will be used to designate the zones to be scratched in the card. This number is then coupled with one or more zones to be scratched carried by the document 3. Indeed, the bar codes have to be specific to the mobile telephone used in order to curb piracy.

The bar code thus read may furthermore comprise an identification of its own edition. In this case, the bar codes are preferably unique. After the reading and the corresponding programming of the telephone 1, during a subsequent connection of the telephone 1 with the services of the mobile telephony operator, this scratch card identity number is neutralized so that another user who might use the same scratch card subsequently (with a common IMEI number part or by concealing the already scratched zones and by scratching other zones) cannot benefit from additional functions assigned to the first user of the card. To this end, the operator updates a file of the neutralized scratch cards. In this case, the telephone comprises circuits to pick up images of bar codes and to put out signalling signals used to transcode a signal encoded according to a bar code protocol into a signal coded according to a mobile telephony protocol.

Another way to program the mobile telephone would be the following: the bar codes could be given conventionally through the press or electronically by Internet. Using a computer screen, the bar codes may be presented before the camera objective.

The use of the bar codes may also relates to communications between mobile telephones: a mobile telephone shows a bar code on its screen 7, placed so as to be facing the camera of another mobile telephone.

At the technical level, the principles of the reading and interpretation of the bar codes are known. The telephone then comprises especially a program memory that stores a sub-program used to convert a signal in a video format picked up by the camera and representing an image of a bar code to be read into a digital format signal representing this bar code. In the invention, the camera used records 200 by 200 pixel images. If a 3×3 pixel block is assigned to define one bar of a code (with a binary significance depending on whether the pixel is black or white), it is possible in this way, using a bar code that takes up the entire registered image, to transmit information equal to four kbits. Such a quantity of information would then be sufficient to contain the parameters and the instructions of the unlocking program 32 if it is not already present in the memory 29 .

In this case the 2D bar code will preferably have patterns used to focus the focal length of the camera . The screen of the telephone 1 is also used to center the reading of the bar code .

According to one embodiment an interposed support ensuring an appropriate distance between the bar code and the objective of the camera 2 is made available to the user.

Furthermore, a device comprising a set of bar codes may be used to parametrize telephones 1 , for example in the case of the use of video cassettes as a means of computer storage. This device comprises a protocol of acknowledgement by the telephone 1 of an accurate reading of a bar code. This acknowledgement may also be expressed for example by a signal sent by a network diode of the telephone 1. This acknowledgement may also take the form of a flashing of the screen 7 (black and white flashing or red flashing for example) or by a sound signal. This acknowledgement provides for the driving of a diaporama of the device.

This parameterization process can be achieved for example by means of a monitor screen or by means of slides type projection. Thus, a parallel arrangement of the process with several mobile telephones observing the same pattern is possible.

In one embodiment, the use of the color camera can enable the use of color bar codes. Thus, the color parameter is used to define additional information.

It may happen that the telephone 1 does not have a back panel connector . The telephone 1 does not set up any serial electrical link. Since the operations of parameterization of the telephone 1 do not require any opening of the telephone, they will be done by means of interpretations of bar code images.

What is claimed is:

1. A mobile telephone comprising a camera, a microprocessor and a program memory wherein, to read bar codes with the camera, the program memory memorizes a sub-program by which a signal in a video format, recorded by the camera and representing an image of a bar code to be read, is converted into a digital format signal representing this bar code, and wherein the mobile telephone comprises circuits to interpret these bar codes.

2. A telephone according to claim 1, comprising circuits to show a decoded transcription of the image of the bar code on a screen of the telephone.

3. A telephone according to one of the claims 1 to 2, comprising circuits to pick up images of bar codes, an circuits to edit signalling signals resulting from a transcoding of an signal encoded according to a bar code protocol into a signal encoded according to a mobile telephone protocol.

4. A telephone according to one of the claims 1 to 3, comprising a memory to memorize data contained in a bar code.

5. A telephone according to one of the claims 1 to 4, comprising circuits to modify a program memory of the telephone as a function of an interpretation of a read bar code.

6. A telephone according to one of the claims 1 to 5, wherein the camera is directed from a side of the pack of the telephone where there is no screen.

7. A telephone according to one of the claims 1 to 6, wherein the camera is mounted on a swivelling shutter.

8. A telephone according to one of the claims 1 to 7, comprising circuits so that a use of a camera is a function of the orientation.

9. A telephone according to one of the claims 1 to 8, comprising an indicator of the focusing of an image of a bar code.

10. A telephone according to one of the claims 1 to 9, not comprising any back panel connector.

11. A method for the programming of a mobile telephone, comprising the following steps
a bar code is read with a camera of this mobile telephone,
and the telephone is programmed with the contents of a bar code read.

12. A method according to claim 11, wherein:
an identity of a read bar code is transmitted to an operator.
